(19) United States
(12) Patent Application Publication
(10) Pub. No.: US 2026/0119867 A1
(43) Pub. Date: Apr. 30, 2026

(54) METHOD OF OPERATION OF MEMORY DEVICE FOR ACCELERATING COMPUTING IN MEMORY

(71) Applicant: KOREA UNIVERSITY RESEARCH AND BUSINESS FOUNDATION, Seoul (KR)

(72) Inventors: Jongsun Park, Seoul (KR); Junwoo Park, Seoul (KR); Kyeong-ho Lee, Seoul (KR)

(21) Appl. No.: 19/271,647

(22) Filed: Jul. 16, 2025

(30) Foreign Application Priority Data
Oct. 31, 2024 (KR) 10-2024-0152581

(51) Int. Cl. G06N 3/08; G06F 7/78; G06F 17/16

(52) U.S. Cl. CPC G06N 3/08; G06F 7/78; G06F 17/16

(57) ABSTRACT

Disclosed is a method of operating a memory device. The method includes loading a first weight into a first memory macro to generate first data of first matrix data and loading the first data into a second memory macro; loading a second weight into the first memory macro to generate “m” (where “m” is a natural number) pieces of second matrix data and loading the “m” pieces into the second memory macro; performing a first matrix operation using the first data; reloading the first weight into the first memory macro to generate n-th (where “n” is a natural number other than “1”) data of the first matrix data; loading the n-th data into the second memory macro and performing the first matrix operation using the n-th data and corresponding n-th data among the “m” pieces of second matrix data.

### CROSS-REFERENCE TO RELATED APPLICATIONS

This application claims priority under 35 U.S.C. § 119 to Korean Patent Application No. 10-2024-0152581 filed on Oct. 31, 2024, in the Korean Intellectual Property Office, the disclosures of which are incorporated by reference herein in their entireties.

### BACKGROUND

Embodiments of the present disclosure described herein relate to an operating method of a memory device for accelerating a computing in memory.

A Deep Neural Network (DNN) is a field of machine learning that is recently used in various fields such as image analysis, object recognition, and image segmentation. The DNN may generate a result value by multiplying input data and weights based on matrix operations.

Meanwhile, recently, a memory technology called Computing In Memory (CIM) is attracting attention as an accelerator for deep artificial neural networks, but there is a problem that a considerable amount of time is required to perform multiple matrix operations.

### SUMMARY

Embodiments of the present disclosure provide an operation method of a memory device for accelerating a computing in memory.

According to an embodiment of the present disclosure, a method of operating the memory device includes loading a first weight into a first memory macro to generate a first data of a first matrix data, and loading the first data into a second memory macro, loading a second weight into the first memory macro to generate “m” (where, “m” is a natural number) pieces of data of a second matrix data, and loading the “m” pieces of data into the second memory macro and performing a first matrix operation with the first data, and loading the first weight into the first memory macro to generate n-th (where, “n” is a natural number other than “1”) data of the first matrix data, and loading the n-th data of the first matrix data into the second memory macro and performing the first matrix operation with n-th data among the “m” pieces of data of the second matrix data.

According to an embodiment, the second memory macro may perform a transpose matrix multiplication as the first matrix operation.

According to an embodiment, the first matrix data may be matrix data based on a key, and the second matrix data may be matrix data based on a query.

According to an embodiment, the performing of the first matrix operation with the first data may generate “m” result values.

According to an embodiment, the performing of the first matrix operation with the n-th data among the “m” pieces of data of the second matrix data may generate one result value.

According to an embodiment of the present disclosure, a method of operating a memory device includes performing a second matrix operation between r-th (where, “r” is a natural number) data of a third matrix data and an r-th column of a fourth matrix data in a first memory macro, loading a third weight into a second memory macro to generate (r+1)-th data of the third matrix data and loading the (r+1)-th data into the first memory macro, and performing the second matrix operation between the (r+1)-th data of the third matrix data and an (r+1)-th column of the fourth matrix data.

According to an embodiment, the second memory macro may perform a matrix multiplication as the second matrix operation.

According to an embodiment, the third matrix data may be matrix data based on a value, and the fourth matrix data may be matrix data based on a result value of a softmax operation.

According to an embodiment, the method of operating the memory device may include generating a result value corresponding to a row number of the fourth matrix data by the second matrix operation.

According to an embodiment, the loading of the (r+1)-th data may be performed simultaneously with the performing of the second matrix operation on the r-th data of the third matrix data and the r-th column of the fourth matrix data.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a memory device, according to some embodiments of the present disclosure.

FIG. 2 is a block diagram schematically illustrating operations of a first matrix operation method, according to some embodiments of the present disclosure.

FIG. 3A to FIG. 3F are diagrams illustrating a first matrix operation method, according to some embodiments of the present disclosure.

FIG. 4 is a timing diagram associated with a first matrix operation, according to some embodiments of the present disclosure.

FIG. 5 is a block diagram schematically illustrating operations of a second matrix operation method, according to some embodiments of the present disclosure.

FIGS. 6A and 6B are diagrams illustrating a second matrix operation method, according to some embodiments of the present disclosure.

FIG. 7 is a block diagram illustrating a processor of a memory device, according to some embodiments of the present disclosure.

### DETAILED DESCRIPTION

Hereinafter, embodiments of the present disclosure will be described clearly and in detail with reference to the attached drawings.

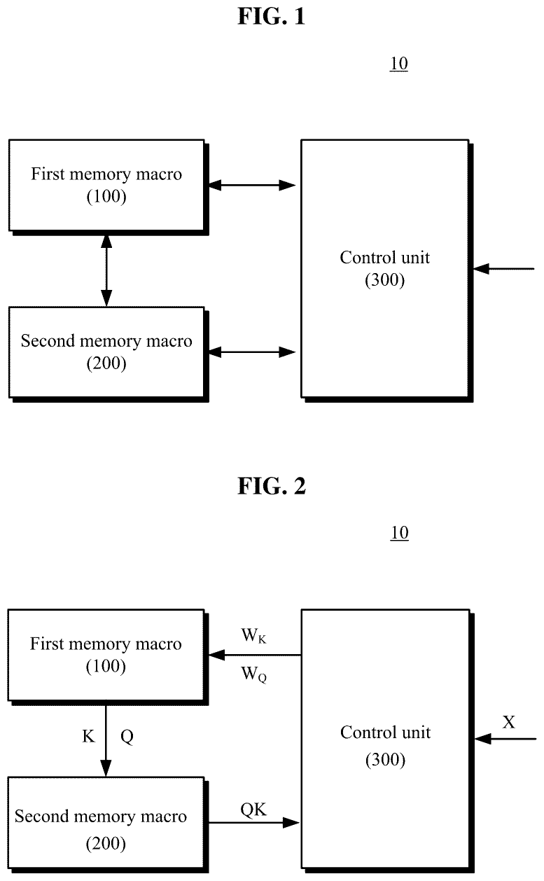

FIG. 1 is a block diagram illustrating a memory device, according to some embodiments of the present disclosure.

Referring to FIG. 1, a memory device 10 according to some embodiments may include a first memory macro 100, a second memory macro 200, and a control unit 300.

In some embodiments, the memory device 10 may be a device for performing a Computing In Memory (CIM) operation and may perform various data processing or matrix operations. For example, the memory device 10 may perform various forms of neural networks trained through machine learning and/or deep learning.

The memory macros 100 and 200 may include a plurality of unit cells to store input data and weights and may perform matrix operations. In this case, the plurality of unit cells may be configured with at least one of a volatile memory and a nonvolatile memory. The volatile memory may include an SRAM (Static RAM), a DRAM (Dynamic RAM), an SDRAM (Synchronous DRAM), and the nonvolatile memory may include a ROM (Read Only Memory), a PROM (Programmable ROM), an EEPROM (Electrically Erase and Programmable ROM), an EPROM (Electrically Programmable ROM), a flash memory, a PRAM (Phase change RAM), an MRAM (Magnetic RAM), an RRAM (Resistive RAM), an FRAM (Ferroelectric RAM), etc. However, this is only an example and is not limited thereto.

The memory macros 100 and 200 may be electrically connected to transmit data. In detail, the memory macros 100 and 200 may perform one or more CIM operations based on stored weights and input data, and may generate output data as a result of the CIM operation.

In this case, the memory macros 100 and 200 may transfer output data to one of the memory macros 100 and 200 in response to the direction in which the weights and/or input data arc input, and the other of the memory macros 100 and 200 may perform matrix operation on the input output data and the weights so as to output a result value. A more detailed description will be described in FIGS. 2 to 7 below.

The control unit 300 may be electrically connected to the memory macros 100 and 200 to control the memory macros 100 and 200. For example, the control unit 300 may transfer weights and input data required for the CIM operation to one of the memory macros 100 and 200, and may receive result values output from one of the memory macros 100 and 200.

In some embodiments, the control unit 300 may generate a first weight, a second weight, a third weight, and a fourth weight from input data input from the outside. In this case, the first weight may be a weight for a key, the second weight may be a weight for a query, the third weight may be a weight for a value, and the fourth weight may be a weight for a result value of a softmax operation.

FIG. 2 is a block diagram schematically illustrating operations of a first matrix operation method, according to some embodiments of the present disclosure.

Referring to FIG. 2, the control unit 300 of the memory device 10 may load a first weight W_{K} and a second weight W_{Q} into the first memory macro 100. In detail, the control unit 300 may generate the first weight W_{K} and the second weight W_{Q} from input data “X” input from the outside.

The first memory macro 100 may receive and load the first weight W_{K} and the second weight W_{Q} from the control unit 300 that is electrically connected. The first memory macro 100 may generate a first matrix data “K” from the first weight W_{K} and a second matrix data “Q” from the second weight W_{Q}. In addition, the first memory macro 100 may load the first matrix data “K” and the second matrix data “Q” into the second memory macro 200.

The second memory macro 200 may receive and load the first matrix data “K” and the second matrix data “Q” from the first memory macro 100 that is electrically connected. The second memory macro 200 may perform a first matrix operation based on the first matrix data “K” and the second matrix data “Q”. In this case, the first matrix operation is an operation on a transpose matrix, and may perform a multiplication between the first matrix data “K” and the second matrix data “Q”. In addition, the second memory macro 200 may transmit a result value QK generated by the first matrix operation to the control unit 300.

In some embodiments, the first memory macro 100 may load the first weight W_{K} to generate first data of the first matrix data “K”. In addition, the first memory macro 100 may load the first data generated from the first weight W_{K} into the second memory macro 200.

In addition, the first memory macro 100 may load the second weight W_{Q} to generate “m” (where, “m” is a natural number) pieces of data of the second matrix data “Q”. The first memory macro 100 may load “m” pieces of data into the second memory macro 200. In this case, the second memory macro 200 may perform a first matrix operation on the first data of the first matrix data “K” that is loaded and the “m” pieces of data of the second matrix data “Q”. In detail, the second memory macro 200 may perform the first matrix operation on the first data and the “m” pieces of data to generate “m” result values QK.

Next, the first memory macro 100 may load the first weight W_{K} to generate an n-th (where “n” is a natural number other than 1) data of the first matrix data “K”, and may load the n-th data into the second memory macro 200. In this case, the second memory macro 200 may perform the first matrix operation on the n-th data among the “m” pieces of data of the second matrix data “Q” that is loaded and the n-th data of the first matrix data “K”. That is, the second memory macro 200 may perform the first matrix operation on the n-th data of the first matrix data “K” and the n-th data of the second matrix data “Q” to generate one result value QK.

As described above, the memory device 10 according to the embodiments of the present disclosure may reduce the loading cycle of weights through the data loading method of the first memory macro 100 and the second memory macro 200 and the first matrix operation method. In other words, the memory device 10 according to the embodiments of the present disclosure may improve the speed of the operation by reducing the loading cycle of weights loaded into the memory macro.

For example, the memory device 10 according to the embodiments of the present disclosure may perform multiple matrix operations for various operations of a deep neural network (DNN), and may improve the operation speed by reducing the loading cycle of weights. Accordingly, the memory device 10 may increase the real-time data processing performance and may enable efficient operation processing.

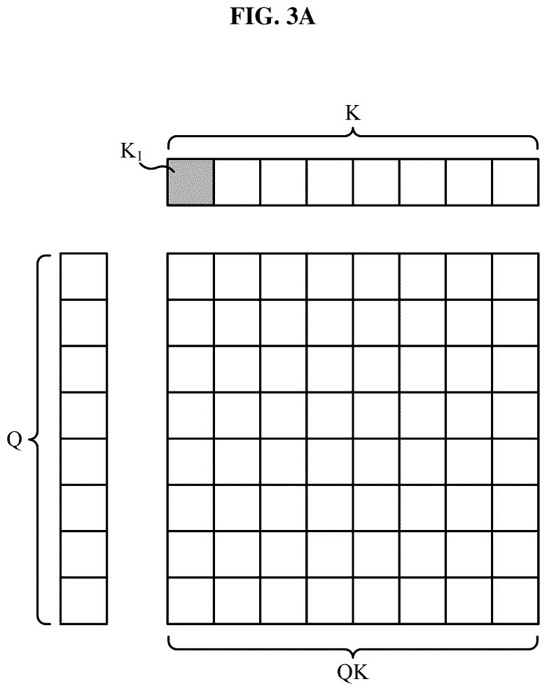

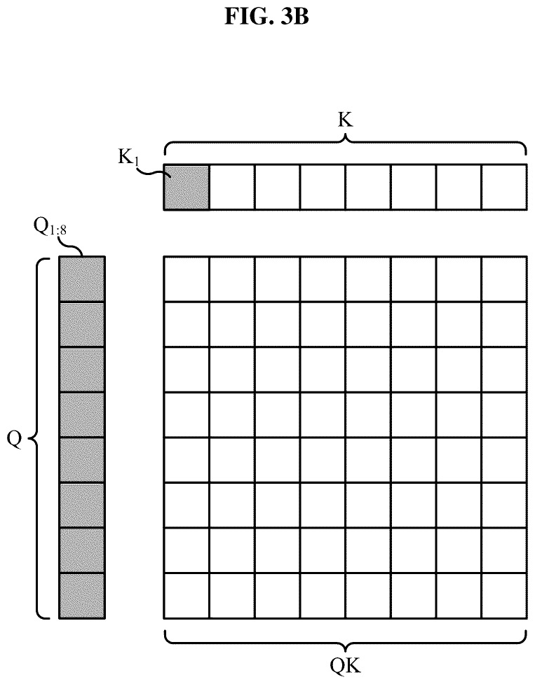

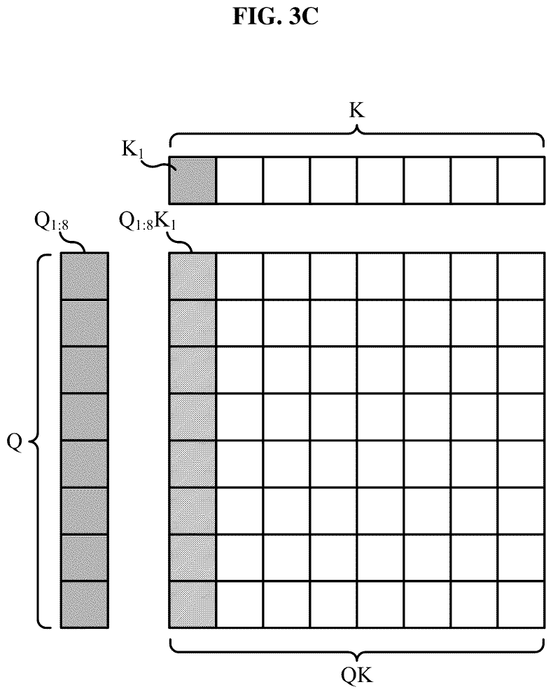

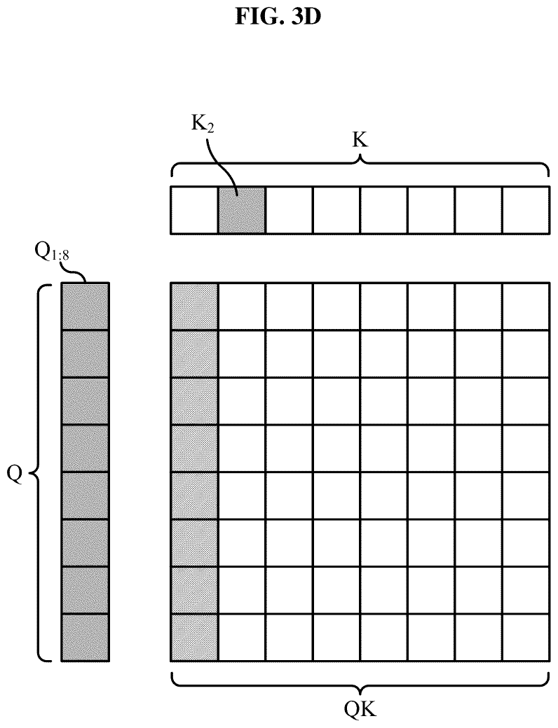

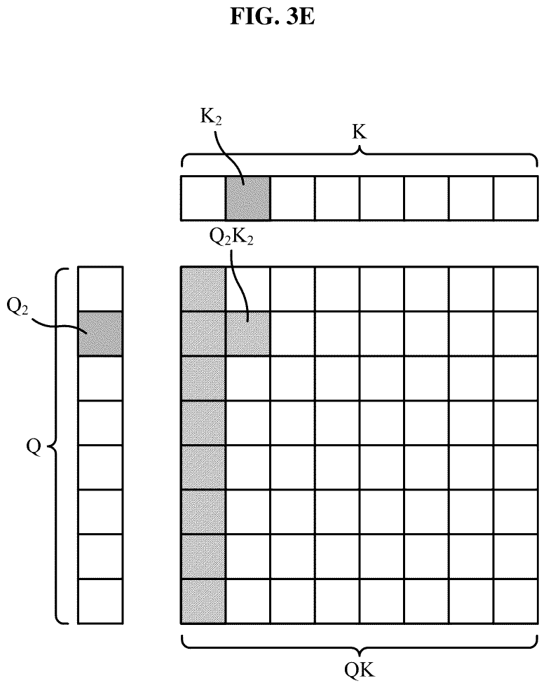

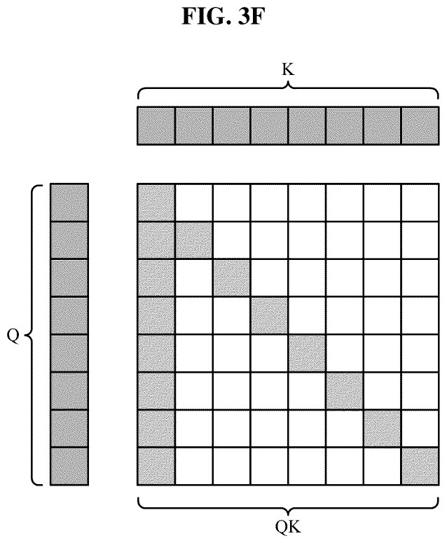

FIG. 3A to FIG. 3E are diagrams illustrating a first matrix operation method, according to some embodiments of the present disclosure. In detail, FIGS. 3A to 3E are diagrams illustrating a first matrix operation method, and FIG. 3F is a diagram illustrating result values QK generated from the first matrix operation. For convenience of description, the following description is based on an 8×8 matrix, but this is only an example and is not limited thereto.

Referring to FIG. 3A, the first memory macro 100 may load the first weight W_{K} to generate first data K₁ of the first matrix data “K”. In addition, the first memory macro 100 may load the first data K₁ of the first matrix data “K” into the second memory macro 200.

Referring to FIG. 3B, the first memory macro 100 may load the second weight W_{Q} to generate “m” pieces of data of the second matrix data “Q”. That is, the first memory macro 100 may generate eight pieces of data Q_{1:8} with respect to the second matrix data “Q”. In addition, the first memory macro 100 may load the eight pieces of data Q_{1:8} of the second matrix data “Q” into the second memory macro 200.

Referring to FIG. 3C, the second memory macro 200 may perform a first matrix operation on the first data K₁ of the first matrix data “K” that is loaded and the eight pieces of data Ques of the second matrix data “Q”. That is, the second memory macro 200 may perform the first matrix operation on the first data K₁ of the first matrix data “K” and the eight pieces of data Ques of the second matrix data “Q” to generate eight result values Q_{1:8}K₁.

Referring to FIG. 3D, the first memory macro 100 may load the first weight W_{K} to generate second data K₂ of the first matrix data “K”. In addition, the first memory macro 100 may load the second data K₂ of the first matrix data “K” into the second memory macro 200.

Referring to FIG. 3E, the second memory macro 200 may perform a first matrix operation using the second data Q₂, which is the second of the “m” data items of the second matrix data “Q” that has been loaded. That is, the second memory macro 200 may perform the first matrix operation on the second data K₂ of the first matrix data “K” and the second data Q₂ of the second matrix data “Q” to generate one result value Q₂K₂.

Referring to FIG. 3F, the memory device 10 may generate result values QK based on the first matrix data “K” and the second matrix data “Q”. In detail, the memory device 10 may perform a matrix multiplication on the first data of the first matrix data “K” and the “m” pieces of data of the second matrix data “Q” to generate “m” result values QK with respect to a first column.

In addition, the memory device 10 may perform the matrix multiplication on the n-th data of the first matrix data “K” and the n-th data among the “m” pieces of data of the second matrix data “Q” to generate one result value QK with respect to the components whose row numbers and column numbers are the same.

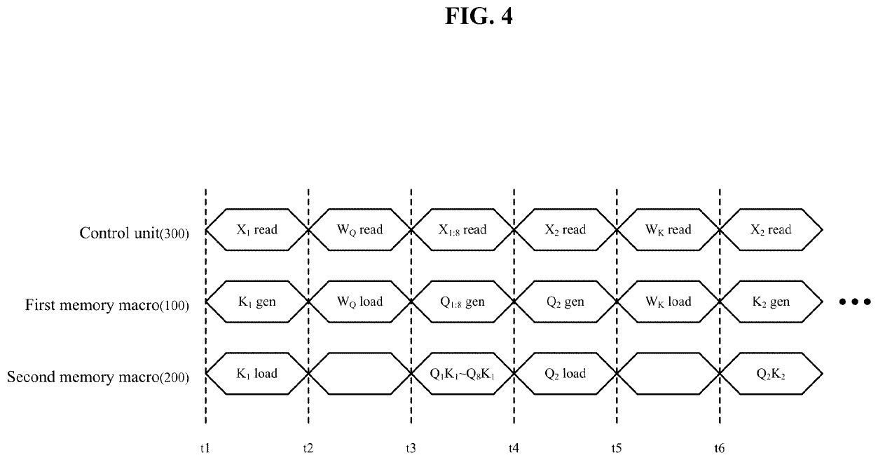

FIG. 4 is a timing diagram associated with a first matrix operation, according to some embodiments of the present disclosure.

Referring to FIG. 4, the memory device 10 may generate the first matrix data “K” and the second matrix data “Q” from the first weight W_{K} and the second weight W_{Q}, and may sequentially perform a first matrix operation between the first matrix data “K” and the second matrix data “Q”.

For example, at a first time t1, the control unit 300 may read out first input data X₁ and may control the first memory macro 100 in response to the first input data X₁. The first memory macro 100 may generate the first data K₁ of the first matrix data “K”, and may load the first data K₁ into the second memory macro 200.

At a second time t2, the control unit 300 may read out the second weight W_{Q} and may control the first memory macro 100 in response to the second weight W_{Q}. The first memory macro 100 may load the second weight W_{Q}.

At a third time t3, the control unit 300 may read out first to eighth input data X_{1:8} and may control the first memory macro 100 in response to the first to eighth input data X_{1:8}. The first memory macro 100 may generate the eight pieces of data Q_{1:8} of the second matrix data “Q” and may load the eight pieces of data Q_{1:8} into the second memory macro 200.

In this case, the second memory macro 200 may generate result values Q_{1:8}K₁ by performing a first matrix operation on the first data K₁ of the first matrix data “K” that is loaded and the eight pieces of data Q_{1:8} of the second matrix data “Q”.

At a fourth time t4, the control unit 300 may read out second input data X₂ and may control the first memory macro 100 in response to the second input data X₂. The first memory macro 100 may generate the second data Q₂ of the second matrix data “Q” using the second weight W_{Q} that is loaded at the second time t2 and may load the second data Q₂ into the second memory macro 200.

At a fifth time t5, the control unit 300 may read out the first weight W_{K} and may control the first memory macro 100 in response to the first weight W_{K}. The first memory macro 100 may load the first weight W_{K}.

At a sixth time t6, the control unit 300 may read out the second input data X₂ and may control the first memory macro 100 in response to the second input data X₂. The first memory macro 100 may generate the second data K₂ of the first matrix data “K”, and may load the second data K₂ into the second memory macro 200.

In this case, the second memory macro 200 may generate a result value Q₂K₂ by performing a first matrix operation on the second data Q₂ of the second matrix data “Q” that is loaded and the second data K₂ of the first matrix data “K”.

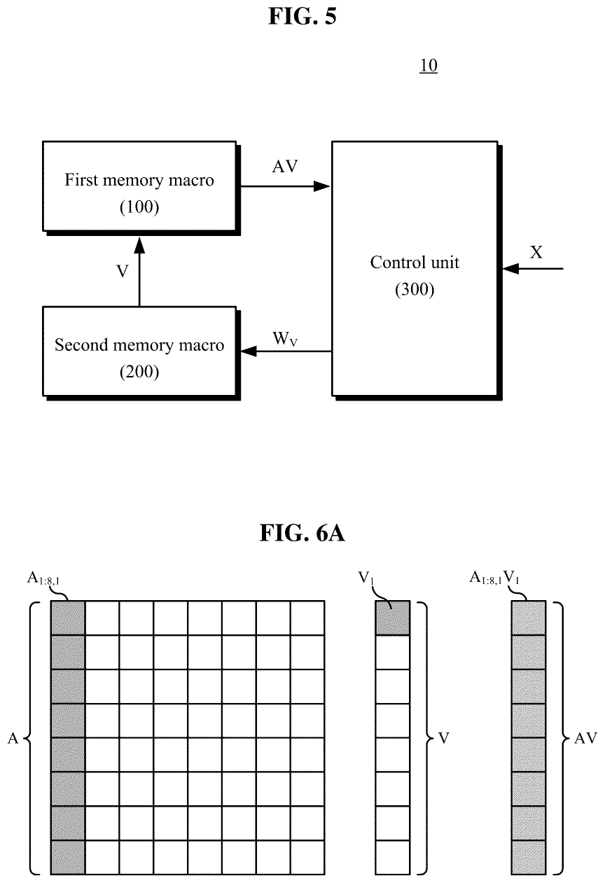

FIG. 5 is a block diagram schematically illustrating operations of a second matrix operation method, according to some embodiments of the present disclosure.

Referring to FIG. 5, the control unit 300 of the memory device 10 may load a third weight W_{V} into the second memory macro 200. In detail, the control unit 300 may generate the third weight W_{V} from input data X input from the outside. In this case, fourth matrix data “A” may be loaded into the first memory macro 100 in advance.

The second memory macro 200 may receive and load the third weight W_{V} from the control unit 300 that is electrically connected. The second memory macro 200 may generate a third matrix data “V” from the third weight W_{V}. In addition, the second memory macro 200 may load the third matrix data “V”.

The first memory macro 100 may receive and load the third matrix data “V” from the second memory macro 200 that is electrically connected. The first memory macro 100 may perform a second matrix operation based on the third matrix data “V”. In detail, the first memory macro 100 may perform the second matrix operation based on the third matrix data “V” and the fourth matrix data “A” that is loaded in advance.

In this case, the second matrix operation is an operation for a matrix multiplication, and a multiplication between the third matrix data “V” and the fourth matrix data “A” may be performed. In addition, the first memory macro 100 may transmit a result value AV generated by the second matrix operation to the control unit 300.

In some embodiments, the second memory macro 200 may load the third weight W_{V} to generate r-th (where, “r” is a natural number) data of the third matrix data “V”. In addition, the second memory macro 200 may load the r-th data of the third matrix data “V” into the first memory macro 100.

The first memory macro 100 may perform a second matrix operation on an r-th column of the fourth matrix data “A” that is loaded and the r-th data of the third matrix data “V”. That is, the first memory macro 100 may generate the result value AV corresponding to the row number of the fourth matrix data “A” by using the second matrix operation.

Next, the second memory macro 200 may generate (r+1)-th data of the third matrix data “V” by using the third weight W_{V} that is loaded. In addition, the second memory macro 200 may load the (r+1)-th data of the third matrix data “V” into the first memory macro 100. Accordingly, the first memory macro 100 may perform a second matrix operation on the (r+1)-th column of the fourth matrix data “A” that is loaded and the (r+1)-th data of the third matrix data “V”.

In this case, the first memory macro 100 may perform a second matrix operation on the r-th column of the fourth matrix data “A” and the r-th data of the third matrix data “V” while loading the (r+1)-th data of the third matrix data “V”.

In some embodiments, the first memory macro 100 and the second memory macro 200 may include at least one buffer (not illustrated). For example, the second memory macro 200 may load the r-th data of the third matrix data “V” generated from the third weight W_{V} into a buffer (not illustrated) of the second memory macro 200 while generating the (r+1)-th data.

In addition, the first memory macro 100 may load the r-th data of the third matrix data “V” into a buffer (not illustrated) of the first memory macro 100 and may perform a second matrix operation on the r-th data and the r-th column of the fourth matrix data “A”. At the same time, the first memory macro 100 may load the (r+1)-th data of the third matrix data “V” into another buffer (not illustrated) of the first memory macro 100.

As described above, the memory device 10 according to the embodiments of the present disclosure may improve the utilization of the memory macros through the data loading method and the second matrix operation method of the first memory macro 100 and the second memory macro 200. In other words, the memory device 10 of the present disclosure may improve the utilization of the memory macros by generating and loading data necessary for the matrix operation in parallel.

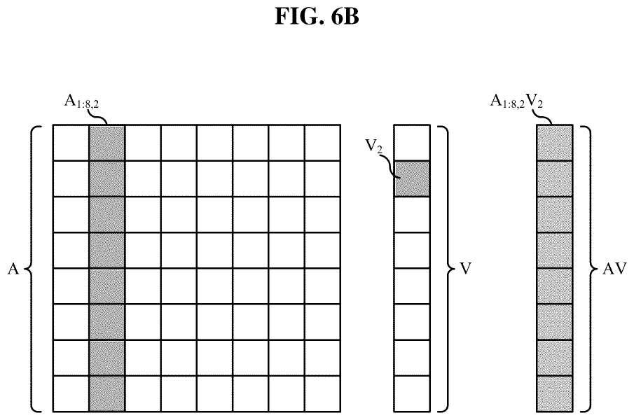

FIGS. 6A and 6B are diagrams illustrating a second matrix operation method, according to some embodiments of the present disclosure. For convenience of description, the following description is based on an 8×8 matrix, but this is only an example and is not limited thereto.

Referring to FIG. 6A, the second memory macro 200 may load the third weight W_{V} to generate first data V₁ of the third matrix data “V”. In addition, the second memory macro 200 may load the first data V₁ of the third matrix data “V” to the first memory macro 100.

In this case, the first memory macro 100 may perform a second matrix operation on a first column A_{1:8.1} of the fourth matrix data “A” that is loaded and the first data V₁ of the third matrix data “V” to generate result values A_{1:8.1}V₁.

Referring to FIG. 6B, the second memory macro 200 may generate second data V₂ of the third matrix data “V” from the third weight W_{V} that is loaded. In addition, the second memory macro 200 may load the second data V₂ of the third matrix data “V” to the first memory macro 100.

In this case, the first memory macro 100 may perform a second matrix operation on a second column A_{1:8.2} of the fourth matrix data “A” that is loaded and the second data V₂ of the third matrix data “V” to generate result values A_{1:8.2}V₂.

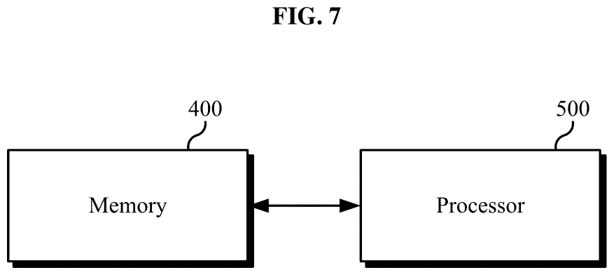

FIG. 7 is a block diagram illustrating a processor of a memory device, according to some embodiments of the present disclosure.

Referring to FIG. 7, a memory 400 may be connected to a processor 500 and may store various information related to operations of the processor 500. For example, the memory 400 may store software codes including instructions for performing some or all of the processors controlled by the processor 500 or for performing the description, function, procedure, proposal, method, and/or operation flowchart of the present disclosure.

The processor 500 may control the memory 400 and may be configured to execute instructions stored in the memory 400 to implement the description, function, procedure, proposal, method, and/or operation flowchart of the present disclosure.

According to an embodiment of the present disclosure, the memory device may improve the operation speed by reducing the loading cycle of the weights loaded into the memory macro. In addition, according to an embodiment of the present disclosure, the memory device may improve the utilization rate of the memory macro by generating the data required for the matrix operation in parallel.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

This work was supported by the Institute for Information & Communications Technology Planning & Evaluation (IITP) funded by the Ministry of Science and ICT (MSIT), korea (No. 2022-0-00266-002 and No. 00229028).

What is claimed is:

1. A method of operating a memory device, the method comprising:
loading a first weight into a first memory macro to generate a first data of a first matrix data, and loading the first data into a second memory macro;
loading a second weight into the first memory macro to generate “m” (where, “m” is a natural number) pieces of data of a second matrix data, and loading the “m” pieces of data into the second memory macro and performing a first matrix operation with the first data; and
loading the first weight into the first memory macro to generate n-th (where, “n” is a natural number other than “1”) data of the first matrix data, and loading the n-th data of the first matrix data into the second memory macro and performing the first matrix operation with n-th data among the “m” pieces of data of the second matrix data.

2. The method of claim 1, wherein the second memory macro performs a transpose matrix multiplication as the first matrix operation.

3. The method of claim 1, wherein the first matrix data is matrix data based on a key, and
wherein the second matrix data is matrix data based on a query.

4. The method of claim 1, wherein the performing of the first matrix operation with the first data generates “m” result values.

5. The method of claim 1, wherein the performing of the first matrix operation with the n-th data among the “m” pieces of data of the second matrix data generates one result value.

6. A method of operating a memory device, the method comprising:
performing a second matrix operation between r-th (where, “r” is a natural number) data of a third matrix data and an r-th column of a fourth matrix data in a first memory macro;
loading a third weight into a second memory macro to generate (r+1)-th data of the third matrix data and loading the (r+1)-th data into the first memory macro; and
performing the second matrix operation between the (r+1)-th data of the third matrix data and an (r+1)-th column of the fourth matrix data.

7. The method of claim 6, wherein the second memory macro performs a matrix multiplication as the second matrix operation.

8. The method of claim 6, wherein the third matrix data is matrix data based on a value, and
wherein the fourth matrix data is matrix data based on a result value of a softmax operation.

9. The method of claim 6, wherein the method of operating the memory device includes generating a result value corresponding to a row number of the fourth matrix data by the second matrix operation.

10. The method of claim 6, wherein the loading of the (r+1)-th data is performed simultaneously with the performing of the second matrix operation on the r-th data of the third matrix data and the r-th column of the fourth matrix data.
